(19) United States
(12) Patent Application Publication
(10) Pub. No.: US 2016/0063579 A1
(43) Pub. Date: Mar. 3, 2016

(54) Method of Charitable Giving

(71) Applicant: CAREICON LIMITED, Preston (GB)

(72) Inventors: Steven Jackson, Preston (GB); Grant Micheal Briston, Preston (GB); Edward Hibrert, Preston (GB); Matthew Lishman, Preston (GB); Peter Riddell, Preston (GB)

(73) Assignee: CAREICON LIMITED, Preston (GB)

(21) Appl. No.: 14/473,642

(22) Filed: Aug. 29, 2014

(51) Int. Cl. G06Q 30/02

(52) U.S. Cl. CPC G06Q 30/0279; G06Q 50/01

(57) ABSTRACT

A charitable giving method is disclosed that uses a social media platform to bring together individuals, businesses, and charitable causes. The use of the social media platform incentivizes individuals and businesses to increase their financial support to charitable causes. The individuals register certain demographic and psychographic information on the social media platform, and that information is used by the businesses and charitable causes in conjunction with directing charitable giving. The individuals and businesses gain recognition for their charitable donations through a visual representation on the charitable social media platform as well as on other social media platforms where the information is shared. The charitable causes receive an increase in donations and promotion of their charitable missions.

### FIELD OF THE INVENTION

The present invention relates generally to a method for charitable giving and more particularly to a method of charitable giving that includes a social media platform where individuals, businesses, and charitable causes come together to garner and increase charitable support.

### BACKGROUND OF THE INVENTION

It is desirable for individuals and businesses to engage in charitable giving, and it is easier to get individuals and businesses to give financial support to charitable causes when the individuals and businesses are recognized. Social media has become a prominent way in which individuals communicate and where businesses and even charitable causes promote their organizations. Putting individuals, businesses, and charitable causes together on a social media platform aids in bringing these entities together and publicly recognizing charitable giving by individuals and businesses and the purposes and missions of the charitable causes.

The prior art shows some of the solutions that have been created to incentivize businesses and individuals to engage in charitable giving. None of the prior art solutions, however, integrate charitable giving, businesses, and individuals with a social media platform in the way of the current invention.

### SUMMARY OF THE INVENTION

As such, the present invention is directed to a method for providing charitable giving. The method incentivizes both individuals and businesses to provide financial support to charitable causes through public recognition. In addition, the businesses and charitable causes gain access to demographic and psychographic information of the individuals associated with the giving to better market products and charitable missions directly to these individuals.

The current invention comprises providing a social media platform for use on a computer network system wherein at least one individual, at least one charitable cause, and at least one business register information via the social media platform. The individual provides financial support to the charitable cause via the social media platform, and the individual's financial support is shown on the social media platform via a visual representation. The individual can view the charitable activity of other individuals also registered with the social media platform, and can also view his own charitable activity relative to that of the other individuals registered with the social media platform. In addition, the registered business may also provide financial support to the charitable cause as directed by the individual. This charitable contribution is recognized via a visual recognition of the financial support in the form of the business's corporate logo superimposed on the charitable cause's logo on the social media platform. The charitable cause is allowed to maintain a presence on the social media platform and receive financial support from the individuals and businesses via the social media platform. The demographic and psychographic analytic information about the choices individuals have made are aggregated and the information is relayed to the business and the charitable cause.

It is an object of the present invention to increase financial support to charitable causes through the use of a social media platform.

It is a further object of the invention to incentivize individuals to encourage others to support the charitable cause that they wish.

It is a further object of the invention to recognize businesses for their charitable support.

It is a further object of the invention to provide financial support and awareness to charitable causes.

It is a further object of the invention to provide businesses and charitable causes with promotional marketing.

It is a further object of the invention to provide demographic and psychographic information of interested individuals to businesses and charitable causes.

The novel features that are considered characteristic of the invention are set forth with particularity in the appended claims. The invention itself, however, both as to its structure and its operation together with the additional object and advantages thereof will best be understood from the following description of the preferred embodiment of the method for charitable giving. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C. §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1 is a flowchart outlining the sign up process for an individual, business, or charitable cause on a social media platform.

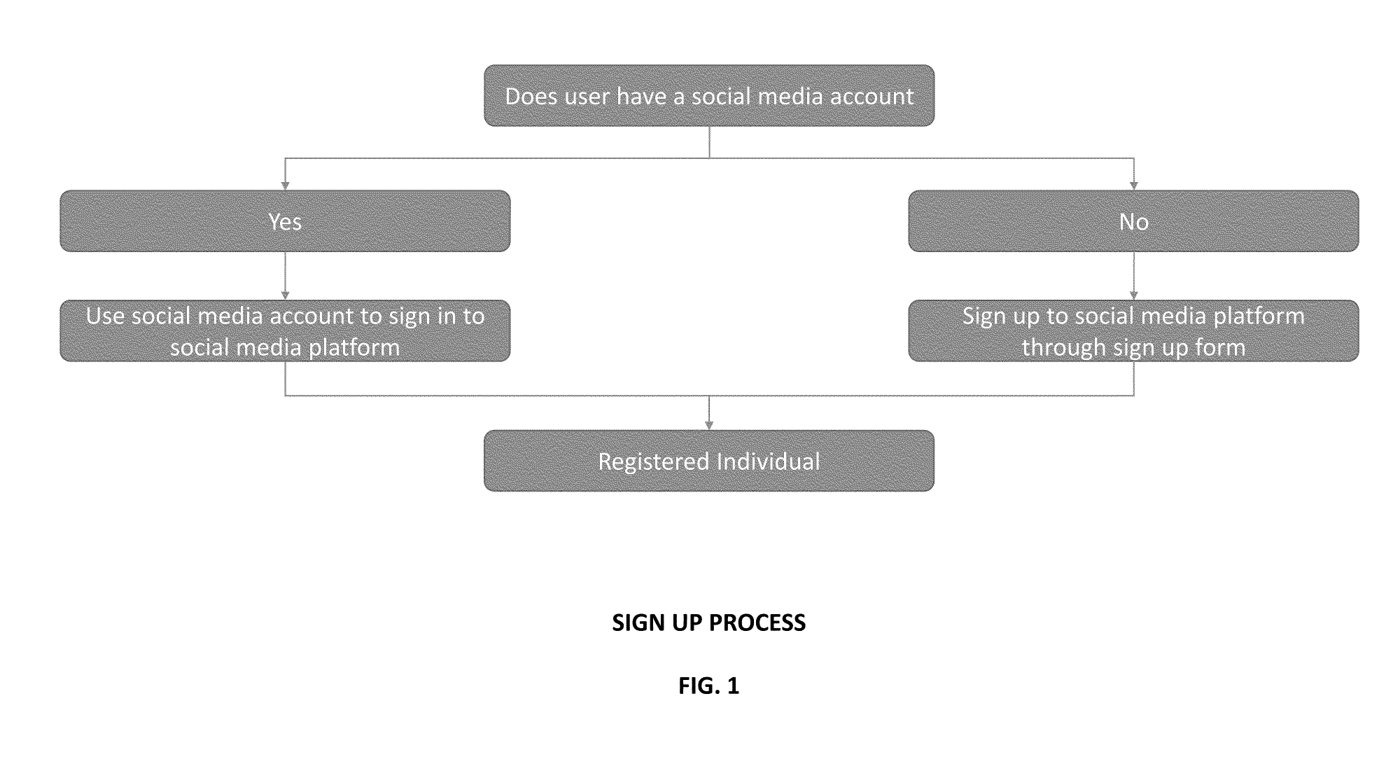

FIG. 2 is a flowchart outlining the attraction of an individual to the social media platform.

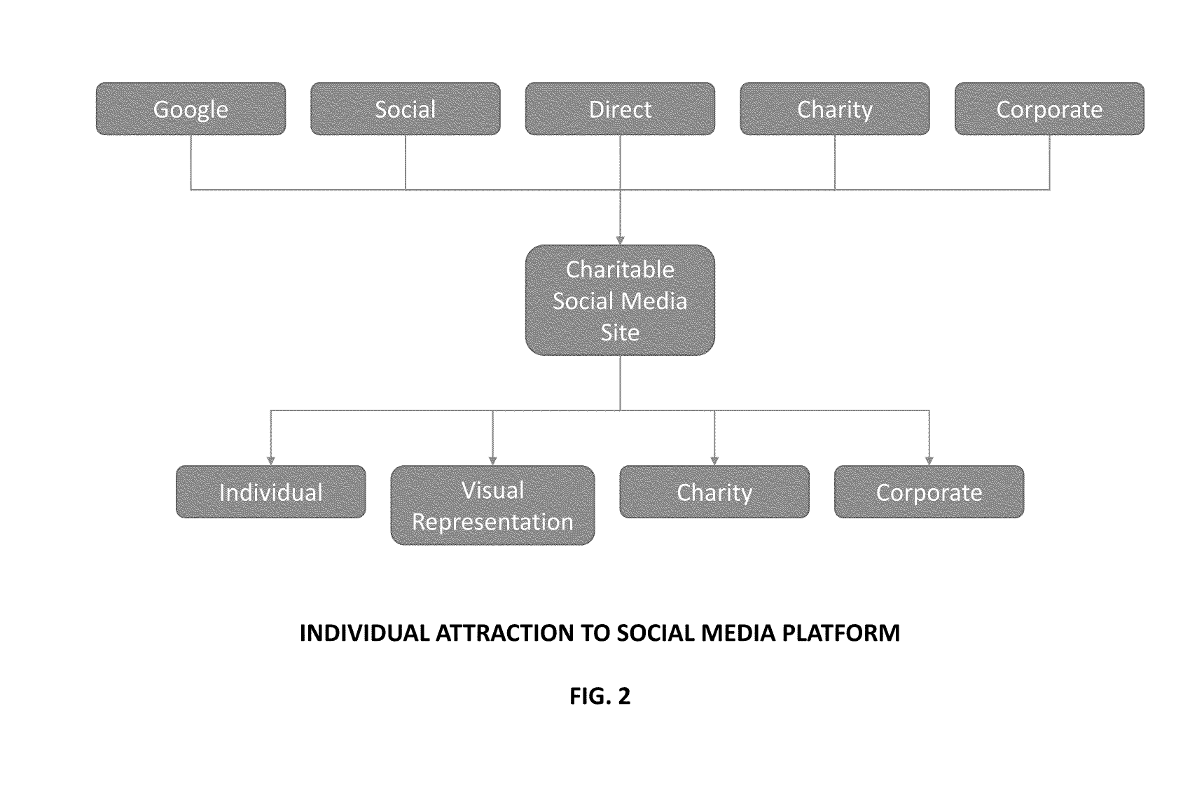

FIG. 3 is a flowchart outlining the activities that can performed by an individual using the social media platform.

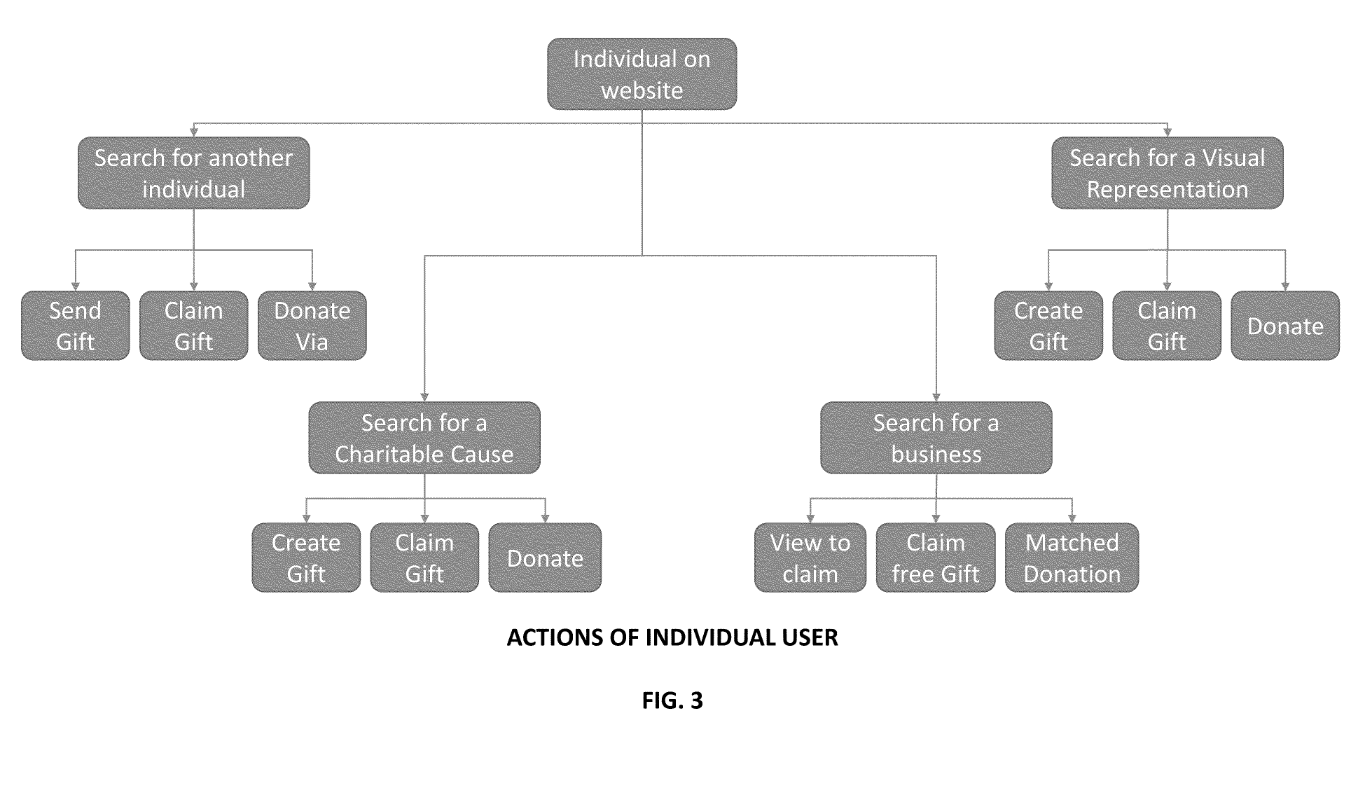

FIG. 4 is a flowchart outlining the activities that can be performed by a business using the social media platform.

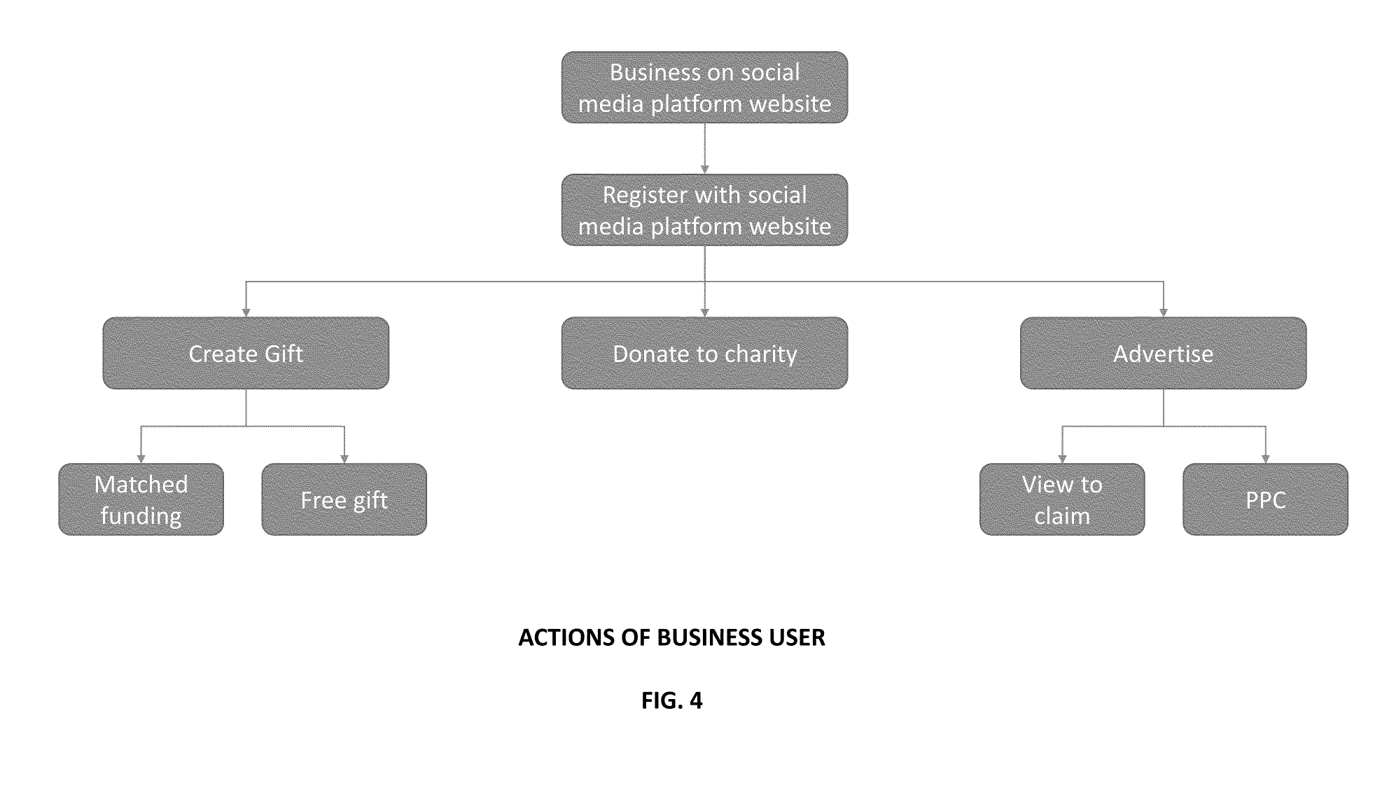

FIG. 5 is a flowchart outlining the activities that can be performed by a charitable cause using the social media platform.

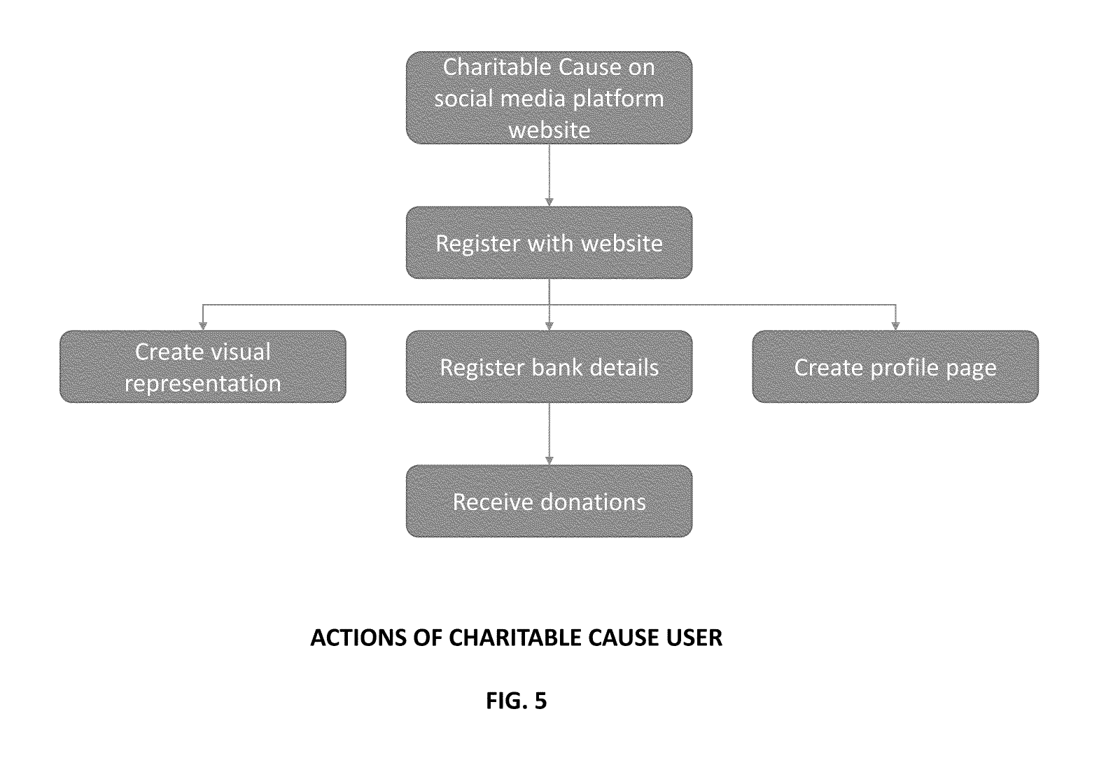

### DESCRIPTION OF PREFERRED EMBODIMENTS

The present invention relates to a method for charitable giving. The preferred method of the invention includes a social media platform for charitable causes. The social media platform is used in conjunction with a computer network system and allows individuals, businesses, and charitable causes to come together to mutually provide benefits to all parties while increasing financial giving to charitable causes. The social media platform can be used on any type of computing devices including, but not limited to, personal computers, tablets, mobile devices, and smart phones.

The individuals, businesses, and charitable causes access the social media platform and register with the platform. In order to register with the platform, the individuals, businesses, and charitable causes are required to input certain information into a database that is maintained with the social media platform on a computer network system. Some of the information that is required includes demographic and psychographic information, location, gender, and age. In addition to these items, other information may be required depending on the goals of the social media platform provider and/or the individuals, businesses, and charitable causes. Once the individuals, businesses, and charitable causes register with the social media platform, they each have their own personal social profile that other users of the social media platform can view.

The social media platform permits individual users to provide financial support for charitable causes and show their support via a visual representation on their personal social media profile. This support can also be integrated with other social media platforms used by the individual and can show support of certain causes on the other social media platforms as well. Within the charitable social media platform, the individual can see the charitable activity of other users of the platform as well as his own charitable activity relative to that of other individual users of the charitable social media platform.

The individuals can also provide financial support to the charitable causes via a gift. This gift can be given to a specific individual or a group of individuals identified by demographic and psychographic factors. The gifts can be virtually wrapped from the giver based on occasion or other personal preferences. Moreover, the individual receiving the gift can accept it or can change it. This gift can be modified by the individual to suit his or her preferences. For example, the individual can select a charitable cause different than the gift giver. This will all be done subject to any conditions put on the gift by the charitable cause or the business.

Additionally, the individuals can rate the charitable causes on the social media platform and indicate their own personal level of support to the causes. The individuals can also participate in quests or other activities that increase engagement with the social media platform and incentivize financial support to the charitable causes on the platform.

The individuals using the social media platform can perform standard social media actions such as posting status updates, linking to other individual users to see their updates, viewing a newsfeed, and viewing news items of geographical relevance to their own location. In addition, the individuals can share their activity on other social media platforms.

The businesses that register with the social media platform provide financial support for the charitable causes directed according to the wishes of the individual platform users. In order to facilitate this, the businesses set up gifts as discussed above. These gifts are either restricted to a certain charitable cause or causes, or they are unrestricted. When the individual accepts a gift from a business, the individual selects the charitable cause to which he wants the funds to be sent. The social media platform tracks the funds due to each charitable cause and enables the funds to be properly distributed. In exchange for allowing the individual users to direct the financial support of the businesses, the businesses may receive a visual recognition of the support in the form of their corporate logo superimposed on the charitable cause's logo visible on the social media platform. In addition, the businesses receive aggregated demographic and psychographic analytic information about the choices the individual users of the social media platform have made. This information is of value to the businesses in that it provides information relating to the tastes of the individuals allowing the businesses to better market their products and services.

Psychographic information is the information that includes the demographic information provided by the individual coupled with the emotional information that is acted upon by the individual. This emotional information can include the physical location of the individual at the time of the donation (e.g. at a particular business, hospital, sporting event, etc.). It can also include information relating to TV or other media coverage of charitable causes that occur at the time the donation was made. The timing of holidays (e.g. Mother's Day, Christmas, Thanksgiving, etc.) and peer activity (e.g. whether the individual's social media connections are simultaneously donating) relative to the time a donation is made by an individual can also be captured as part of the emotional information gathered. These pieces of information are used to identify the motivation that prompted a particular individual to donate at a certain time or place.

The businesses can offer contributions as gifts available to an individual to direct to the charitable causes of the individual's choice. These gifts can be subject to restrictions imposed by the business and/or the charitable cause. These gifts can be made to require a matched donation thereby increasing the overall charitable support. The matched portion of the gift can be either a one to one match or some other type of varying ratio. For example, the business could offer $4.00 for every $1.00 offered by the individual. The gifts can be made available on an individual's demographic and psychographic basis that is based on the information that the individual uses when registering on the social media platform.

The charitable causes that register and use the social media platform maintain a presence on the social media platform and receive financial support from the individuals and businesses also registered and using the social media platform. The result of the use of the social media platform for charitable giving is to make charitable giving a more rewarding experience for the individuals, businesses, and charitable causes. This causes increased financial support flowing to the charitable causes while at the same time adding a benefit to the individual and the business.

The social media platform of the invention allows individuals, charitable causes, and businesses to register on the platform. The information provided by these entities is maintained in a database that is used in conjunction with the social media platform. In addition, ranking information relating to the charitable causes is maintained on a database used with the social media platform. This ranking information is presented on the social media platform in the form of lists. These lists include information describing the most generous individuals, the individuals who have inspired the most donations from other users, the charitable causes that have raised the most support, and the businesses that have provided the most support. The social media platform can also display a geographical map that shows the relative charitable activity of individuals within a specific geographical area. This map can be panned and zoomed by the individual.

In addition, the businesses or charitable causes can include a requirement that a sponsor video be watched prior to contribution activity on the social media profile. This could be expanded to include other interactive activities to reach the contribution activity, such as answering multiple choice questions, taking a quiz, etc. This interaction increases the individual's time becoming aware of the business, and thus, provides a benefit to the business.

The preferred embodiment of the invention is described in the Description of Preferred Embodiments. While these descriptions directly describe the one embodiment, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A method for charitable giving comprising the steps of:
providing a social media platform for use on a computer network system wherein at least one individual, at least one charitable cause, and at least one business register information via the social media platform;
providing financial support from the individual to the charitable cause and showing the individual's financial support on the social media platform via a visual representation;
allowing the at least one individual to view the charitable activity of separate individuals registered with the social media platform;
allowing the at least one individual to view his charitable activity relative to that of the separate individuals registered with the social media platform;
providing financial support from the at least one business to the at least one charitable cause directed according to the at least one individual;
recognizing the at least one business via a visual recognition of the financial support in the form of a corporate logo superimposed on a logo of the at least one charitable cause on the social media platform;
allowing the at least one charitable cause to maintain a presence on the social media platform and receive financial support from the at least one individual and the at least one business via the social media platform; and
aggregating analytic information about the choices individuals have made and relaying the information to the at least one business and the at least one charitable cause.

2. The method of claim 1 further comprising the step of storing and maintaining a database of the information of the at least one charitable cause, the at least one individual, and the at least one business that have registered on the social media platform.

3. The method of claim 1 further comprising the step of allowing the at least one individual to post status updates, link to other individuals, view a news feed, and view news items of geographical relevance to a specific location within the social media platform.

4. The method of claim 1 further comprising the step of allowing individuals to provide financial support to the charitable cause via a gift to a specific individual.

5. The method of claim 1 further comprising the step of allowing individuals to provide financial support to the charitable cause via a gift to individuals identified by demographic factors.

6. The method of claim 1 further comprising the step of allowing individuals to provide financial support to the charitable cause via a gift to individuals identified by geographic location.

7. The method of claim 1 further comprising the step of rating the charitable causes by the individuals and indicating the level of support to each charitable cause.

8. The method of claim 6 further comprising the step of maintaining rating information about support from the individuals and the businesses and received by the charitable causes.

9. The method of claim 6 further comprising the step of presenting the rating information in the form of lists.

10. The method of claim 6 further comprising the step of presenting the rating information in the form of a geographical map relative to charitable activity of individuals within a specific geographic location.

11. The method of claim 9 wherein the geographical map can be panned and zoomed.

12. The method of claim 1 further comprising the step of presenting the individuals with activities to increase engagement with the social media platform and incentivize charitable support.

13. The method of claim 1 further comprising the step of offering contributions from the businesses as gifts available to the individuals to direct to charitable causes of their choice.

14. The method of claim 12 further comprising the step of requiring a matched donation for the gift provided by the businesses.

15. The method of claim 12 further comprising the step of making gifts available to individuals based on demographic information.

16. The method of claim 12 further comprising the step of making gifts available to individuals based on geographic location.

17. The method of claim 1 further comprising the step of allowing individuals, businesses, and charitable causes to maintain images to act as a representation of identity.

18. The method of claim 1 further comprising the step of promoting individuals, businesses, or charitable causes.

19. The method of claim 1 further comprising the step of the individual providing demographic information via the social media platform.

20. The method of claim 1 further comprising the step of sharing the visual representation to other social media platforms.

21. The method of claim 1 further comprising the step of requiring the individual to watch a sponsor video associated with the business or charitable cause.

22. The method of claim 1 further comprising the step of requiring an interaction between the individual and the business.

23. The method of claim 1 further comprising the step of allowing individuals to provide financial support to the charitable cause via a gift to individuals identified by psychographic factors.

24. The method of claim 12 further comprising the step of making gifts available to individuals based on psychographic information.

25. The method of claim 1 further comprising the step of aggregating demographic analytic information about the choices individuals have made and relaying the information to the at least one business and the at least one charitable cause.

26. The method of claim 1 further comprising the step of aggregating psychographic analytic information about the choices individuals have made and relaying the information to the at least one business and the at least one charitable cause.
